(19) United States
(12) Patent Application Publication
(10) Pub. No.: US 2026/0064561 A1
(43) Pub. Date: Mar. 5, 2026

(54) AUTOMATED SOURCE CODE GENERATION AND OPTIMIZATION USING LARGE LANGUAGE MODELS AND REINFORCEMENT LEARNING

(71) Applicant: International Business Machines Corporation, Armonk, NY (US)

(72) Inventors: Bo Wen, Chappaqua, NY (US); Chen Wang, Chappaqua, NY (US); Huamin Chen, Newton, MA (US)

(21) Appl. No.: 18/825,007

(22) Filed: Sep. 5, 2024

(51) Int. Cl. G06F 11/34; G06F 8/41; G06F 11/36

(52) U.S. Cl. CPC G06F 11/3466; G06F 8/443; G06F 11/3428; G06F 11/3688

(57) ABSTRACT

Examples described herein provide a computer-implemented method for automated source code generation and optimization. The method includes receiving goals and parameters via a user interface, such as performance, resource utilization, functionality, security, and sustainability metrics. An initial source code is generated by a large language model based on these goals and parameters, and then compiled into an executable program. The executable program is benchmarked to obtain results, including performance, resource utilization, functionality, security, and sustainability metrics. These benchmarking results are compared to the predefined goals and parameters. If the benchmarking results meet all the specified metrics, the source code and benchmarking results are output via the user interface.

### BACKGROUND

The discourse relates generally to the field of software development, and more specifically to automated source code generation and optimization using large language models and reinforcement learning.

Recent advancements in generative intelligence have enabled significant progress in creating functional source code based on user prompts. The generated code may not meet specific performance, resource, functionality, security, or sustainability metrics desired by developers.

### SUMMARY

Embodiments described herein include a computer-implemented method for automated source code generation and optimization. The method includes receiving, via a user interface, goals and parameters for a source code generation process, wherein the goals and parameters include at least one of performance metrics, resource utilization metrics, functionality metrics, security metrics, and sustainability metrics, obtaining, from a large language model, an initial source code based on the goals and parameters, and compiling the initial source code into an executable program. The method also includes benchmarking the executable program to obtain benchmarking results, wherein the benchmarking results include at least one of performance results, resource utilization results, functionality results, security results, and sustainability results, comparing the benchmarking results to the at least one of performance metrics, resource utilization metrics, functionality metrics, security metrics, and sustainability metrics, and based on a determination that the benchmarking results meet all of the least one of performance metrics, outputting, via the user interface, the source code and the benchmarking results.

A system having a memory comprising computer readable instructions and a processing device for executing the computer readable instructions, the computer readable instructions controlling the processing device to perform operations. The operations include receiving, via a user interface, goals and parameters for a source code generation process, wherein the goals and parameters include at least one of performance metrics, resource utilization metrics, functionality metrics, security metrics, and sustainability metrics, obtaining, from a large language model, an initial source code based on the goals and parameters, and compiling the initial source code into an executable program. The operations also include benchmarking the executable program to obtain benchmarking results, wherein the benchmarking results include at least one of performance results, resource utilization results, functionality results, security results, and sustainability results, comparing the benchmarking results to the at least one of performance metrics, resource utilization metrics, functionality metrics, security metrics, and sustainability metrics, and based on a determination that the benchmarking results meet all of the least one of performance metrics, outputting, via the user interface, the source code and the benchmarking results.

A computer program product for circuit design optimization, the computer program product includes a set of one or more computer-readable storage media and program instructions, collectively stored in the set of one or more storage media, for causing a processor set to perform computer operations. The operations include receiving, via a user interface, goals and parameters for a source code generation process, wherein the goals and parameters include at least one of performance metrics, resource utilization metrics, functionality metrics, security metrics, and sustainability metrics, obtaining, from a large language model, an initial source code based on the goals and parameters, and compiling the initial source code into an executable program. The operations also include benchmarking the executable program to obtain benchmarking results, wherein the benchmarking results include at least one of performance results, resource utilization results, functionality results, security results, and sustainability results, comparing the benchmarking results to the at least one of performance metrics, resource utilization metrics, functionality metrics, security metrics, and sustainability metrics, and based on a determination that the benchmarking results meet all of the least one of performance metrics, outputting, via the user interface, the source code and the benchmarking results.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 illustrates a block diagram of a computing environment, according to one or more embodiments;

FIG. 2 illustrates a block diagram of a system for automated source code generation and optimization using large language models and reinforcement learning, according to one or more embodiments;

FIG. 3 illustrates a process flow for automated source code generation and optimization using a combination of LLMs and reinforcement learning, according to one or more embodiments; and

FIG. 4 illustrates a flow chart diagram of a method for automated source code generation and optimization using large language models and reinforcement learning, according to one or more embodiments.

The detailed description explains embodiments of the disclosure, together with advantages and features, by way of example with reference to the drawings.

### DETAILED DESCRIPTION

Reinforcement learning (RL) algorithms, widely used in various applications, primarily operate as blackbox software. These algorithms tune parameters to gather new information and optimize solutions. Despite their effectiveness, current RL processes do not extend to whitebox, source code level tuning. This limitation restricts their applicability in generating and fine-tuning software programs based on comprehensive test results beyond performance metrics. Existing solutions focus predominantly on performance metrics, neglecting other aspects such as resource utilization, functionality, security, and sustainability.

Exemplary embodiments include methods, systems, and computer program products that are configured to automatically generate and optimize source code using a combination of large language models (LLMs) and RL. The system leverages LLMs to generate initial source code based on defined goals, which may include performance, resource, functionality, security, and sustainability metrics. The generated source code undergoes a compilation process, transforming the source code into an executable program. A benchmarking module then runs the executable program, obtaining various metrics. These metrics are fed back to the LLM, which iteratively improves the source code until the predefined goals or another termination condition is reached. This iterative loop ensures that the generated source code meets the desired metrics, providing a comprehensive solution for automated source code generation and optimization.

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

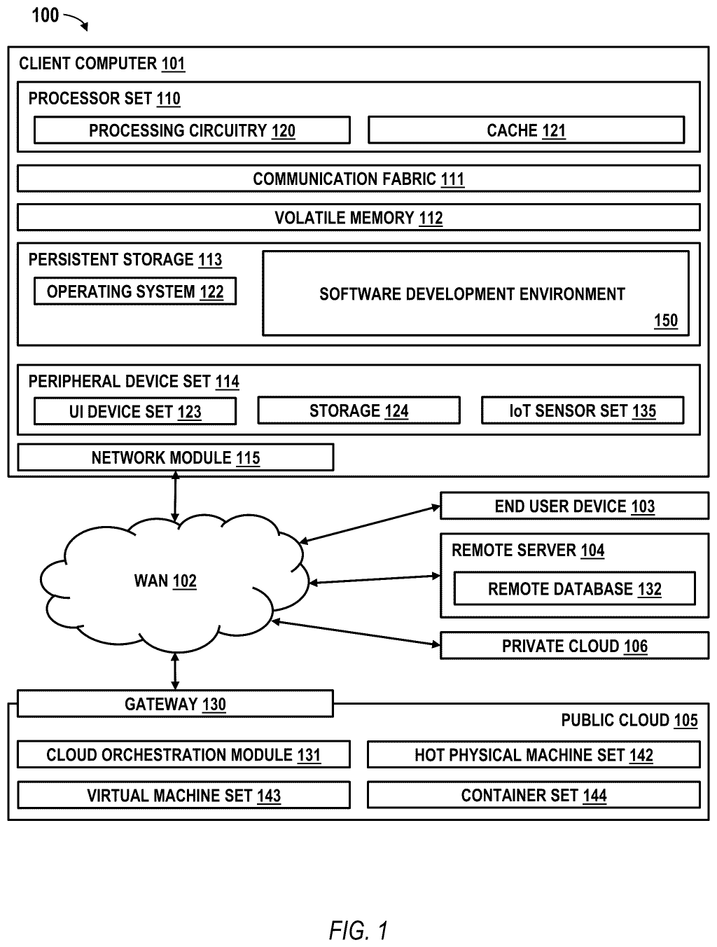

FIG. 1 illustrates a computing environment 100, according to an embodiment. Computing environment 100 contains an example of an environment for the execution of at least some of the computer code involved in performing the inventive methods, such as a software development environment 150 for automated source code generation and optimization. In addition to the software development environment 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and software development environment 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in the software development environment 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in software development environment 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to one or more embodiments, the computing environment 100 can provide for remote data storage. For example, the computer 101 can be a cloud storage system or other suitable system for storing data that is accessible to a user remotely, such as by accessing the computer 101 using the end user device 103. That is, a user can send a user operation (also referred to as a “user request”) from the end user device 103 to the computer 101 via the WAN 102. Although the user operation may appear to be simple, such as uploading an object to a cloud storage system, the complications of operating a cloud computing system often have side effects and produce ancillary data, which may be consumed by both the operator of the system (e.g., the computer 101) and by users or other components of the cloud architecture (e.g., the computing environment 100). Ancillary data may be created by user operations that trigger the creation of the ancillary data. Ancillary data may be resource consumption information, notification data, and/or the like, including combinations and/or multiples thereof. Data for an independent event may be inferred from another event (e.g., event to update resource consumption information for an entity in a system also means that the total consumption information for the owner of the entity is also updated).

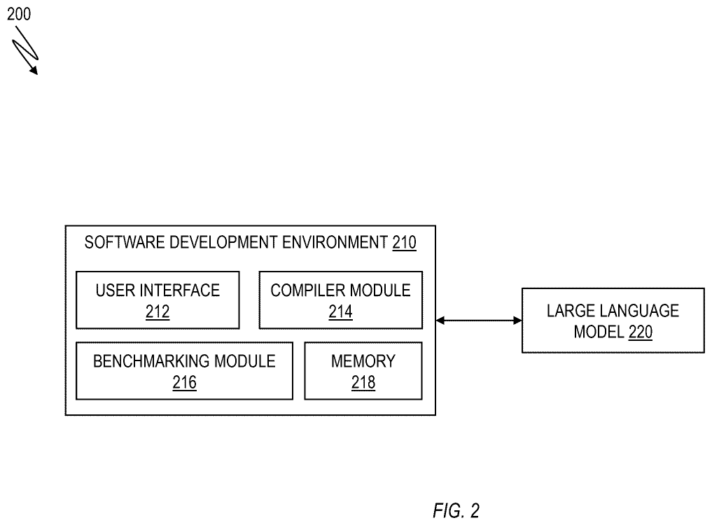

Referring now to FIG. 2, a block diagram of a system 200 for automated source code generation and optimization using large language models and reinforcement learning is shown. In exemplary embodiments, the system 200 includes a software development environment 210 and a large language model (LLM) 220. The software development environment 210 includes a user interface 212, a compiler module 214, a benchmarking module 216, and a memory 218. The LLM 220 interacts with the software development environment 210 to facilitate automated source code generation and optimization.

In exemplary embodiments, the software development environment 210 serves as the primary environment where the source code generation and optimization processes occur. The software development environment 210 integrates various modules to support the development and refinement of source code based on predefined metrics.

In exemplary embodiments, the user interface 212 of the software development environment 210 provides a platform for developers to input goals and parameters for the source code generation process and to receive the output of the automated source code generation. The user interface 212 allows users to define performance, resource, functionality, security, and sustainability metrics that guide the LLM 220 in generating the initial source code. In addition, the user interface 212 is configured to provide the results of the automated software code generation to the user via a display.

In exemplary embodiments, the compiler module 214 of the software development environment 210 compiles the source code generated by the LLM 220 into an executable program. The compiler module 214 ensures that the source code is syntactically correct and can be executed to perform the desired functions.

In exemplary embodiments, the benchmarking module 216 of the software development environment 210 runs the compiled executable program to obtain various metrics. The benchmarking module 216 evaluates the performance, resource utilization, functionality, security, and sustainability of the executable program, providing feedback for further optimization. In exemplary embodiments, the benchmarking module 216 is configured to execute various test cases on the compiled executable program to obtain the various metrics. In one embodiment, the test cases may be generated by the LLM based on prompts from the user and/or the software development environment 210.

In exemplary embodiments, the memory 218 of the software development environment 210 stores the generated source code, compiled executables, and benchmarking results. The memory 218 retains the data necessary for the iterative improvement process, enabling the LLM 220 to refine the source code based on the feedback received.

In exemplary embodiments, the LLM 220 generates the initial source code based on the goals and parameters defined by the User Interface 212. The LLM 220 iteratively improves the source code by incorporating feedback from the benchmarking module 216 until the predefined goals or another termination condition is reached. In exemplary embodiments, the LLM 220 may be one of several commercially available LLMs from various companies and organizations, such as GPT-4 from OpenAI, Google DeepMind, Microsoft's Azure OpenAI Service or Copilot, Claude by Anthropic. LLaMA by Meta, or IBM's Watson. These models are often accessible through APIs or integrated into various software solutions, making them widely available for developers and businesses.

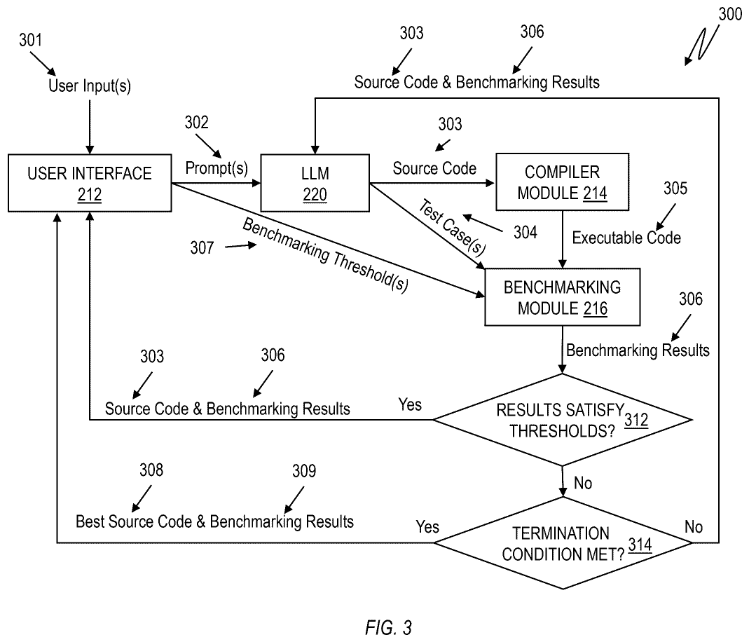

Referring now to FIG. 3, a process flow 300 for automated source code generation and optimization using a combination of LLMs and reinforcement learning is shown. In exemplary embodiments, the process flow 300 can be implemented by the system 200 as described in FIG. 3, which includes the software development environment 150 shown in FIG. 1.

The process flow 300 begins with a user providing user inputs 301 to a user interface 212 of the software development environment. These inputs can include goals and parameters for the source code generation process, such as performance, resource, functionality, security, and sustainability metrics. The types of user inputs that can be provided to the system for automated source code generation and optimization can vary and the inputs are tailored to guide the LLM 220 in generating and refining source code to meet specific requirements. Users can define performance-related goals such as latency, throughput, and execution speed. For example, a user might specify that the generated code should execute a particular function within a certain time frame or handle a specific number of transactions per second. Inputs related to resource usage include CPU and memory utilization. Users can set limits on how much CPU time or memory the generated code should consume. For instance, a user might require that the code operates within a 50% CPU usage threshold or uses no more than 100 MB of memory.

In exemplary embodiments, functionality goals can be used to ensure that the generated code performs the intended tasks correctly. Users can provide unit tests, functional requirements, and expected outputs. For example, a user might input a set of test cases that the code must pass to be considered functional. Security-related inputs focus on minimizing vulnerabilities and ensuring the code adheres to best practices. Users can specify requirements such as the absence of known security flaws, compliance with security standards, and the use of secure coding practices. For example, a user might require that the code passes a security audit or does not contain any SQL injection vulnerabilities.

In exemplary embodiments, sustainability goals can be used to optimize the code for energy efficiency and environmental impact. Users can set targets for performance per watt or overall energy consumption. For instance, a user might specify that the code should achieve a certain level of performance while consuming minimal power. Users can provide external source templates or reference codes that the LLM can use as a basis for generating new code. This helps ensure that the generated code aligns with existing codebases or follows specific coding styles and conventions.

In exemplary embodiments, users can input custom constraints and preferences that the LLM should consider during code generation. These might include preferred programming languages, coding standards, architectural patterns, and specific libraries or frameworks to use or avoid. Users can define the number of iterations the system should perform or set specific termination conditions. For example, a user might specify that the system should stop iterating once the code meets all predefined metrics or after a certain number of iterations. Users can provide descriptive prompts that outline the desired functionality and behavior of the generated code. These prompts can include detailed descriptions of the tasks the code should perform, the expected interactions with other systems, and any specific requirements or constraints. By providing detailed inputs, users can guide the LLM in generating and optimizing source code that meets their specific needs and requirements, ensuring a comprehensive and tailored solution.

After the user inputs 301 are received by the user interface 212, the software development environment provides prompts 302 to the LLM 220. In exemplary embodiments, the prompts guide the LLM 220 in generating the initial source code based on the defined goals and parameters. In exemplary embodiments, the prompts provided to the LLM 220 are created by the software development environment through a combination of user inputs 301 and predefined templates designed to guide the LLM in generating and refining source code. In exemplary embodiments, the software development environment generates prompts 302 that outline the desired functionality and behavior of the generated code. The prompts 302 can include descriptive text that specifies the tasks the code should perform, the expected interactions with other systems, and any specific requirements or constraints. For example, a prompt 302 might instruct the LLM to generate code that performs a specific function within a certain time frame while adhering to security best practices and minimizing CPU usage. In addition to user-defined inputs 301, the software development environment may utilize predefined templates to standardize the prompts and ensure consistency. These templates can be based on common coding practices, industry standards, or specific project requirements. The templates help structure the prompts in a way that the LLM can easily interpret and act upon, ensuring that the generated code aligns with the desired goals. Once the prompts 302 are created, they are fed into the LLM 220, which uses its advanced natural language understanding and generation capabilities to produce the initial source code 303.

The source code 303 generated by the LLM 220 is provided to the compiler module 214, which generates an executable code 305. In exemplary embodiments, the compiler module 214 ensures that the source code 303 is syntactically correct and can be executed to perform the desired functions. Next, the executable code 305 is provided to the benchmarking module 216 which runs the executable code 305 to obtain various metrics. The benchmarking module 216 evaluates the performance, resource utilization, functionality, security, and sustainability of the executable program, providing benchmarking results.

In exemplary embodiments, the benchmarking module 216 is configured to evaluate the quality and performance of the executable code generated by the LLM 220. In one embodiment, the benchmarking module 216 conducts a series of tests to obtain various metrics, ensuring that the code meets the predefined goals and requirements set by the user. The process involves several steps, including the optional use of test cases created by the LLM and the comparison of benchmarking results to benchmarking thresholds obtained from the software development environment based on user inputs. The benchmarking module 216 evaluates the executable code against a range of metrics, which can include performance metrics such as latency and throughput, resource utilization metrics like CPU and memory usage, functionality metrics including unit test correctness, security metrics to identify vulnerabilities, and sustainability metrics such as energy efficiency.

In some cases, the LLM itself can generate test cases based on prompts from the user and the software development environment. These test cases are designed to rigorously evaluate the functionality and performance of the executable code. For example, the LLM might create unit tests to verify that specific functions within the code produce the expected outputs, or it might generate stress tests to assess how the code performs under high-load conditions.

After running the executable code through these tests, the benchmarking module 216 collects the benchmarking results 306 and compiles them into a comprehensive set of benchmarking metrics. These benchmarking results 306 are then compared to the benchmarking thresholds 307 that were defined by the user through the software development environment. The benchmarking thresholds 307 represent the minimum acceptable standards for each metric, ensuring that the generated code meets the user's specific requirements. The comparison process involves evaluating each metric against its corresponding threshold. For instance, if the user has set a performance threshold for latency at 100 milliseconds, the benchmarking module 216 will check if the executable code's latency is within this limit. Similarly, if the user has specified a maximum CPU usage of 50%, the module will verify that the code does not exceed this threshold.

At decision block 312, it is determined whether the benchmarking results 306 meet or exceed the benchmarking thresholds 307. If the benchmarking results 306 meet or exceed the benchmarking thresholds 307, the source code 303 and the benchmarking results 308 are sent to the user interface 212 and are provided to the user. If the benchmarking results 306 do not meet or exceed the benchmarking thresholds 307, the source code 303 and the benchmarking results 308 are sent back to the LLM 220 for iterative refinement. The LLM 220 uses this feedback to generate an improved version of the source code 303, which is then recompiled and retested by the benchmarking module 216. This iterative loop continues until the source code meets all the predefined goals or the determination that another termination condition is reached at decision block 314.

In exemplary embodiments, one or more of multiple types of termination conditions can be defined to determine when the iterative code generation and optimization process should stop. These termination conditions ensure that the system does not continue indefinitely and that the generated code meets the desired criteria. One of the termination conditions is the achievement of predefined goals. These goals can include performance metrics such as latency and throughput, resource utilization metrics like CPU and memory usage, functionality requirements including unit test correctness, security standards to minimize vulnerabilities, and sustainability targets for energy efficiency. Once the benchmarking results indicate that the generated code meets or exceeds all these predefined thresholds, the iterative process can be terminated. Another termination condition is the maximum number of iterations, which may be specified by a user or by the software development environment. The maximum number of iterations is a limit on the number of iterations the system should perform. For example, a user might set a maximum of 50 iterations. If the system reaches this limit without meeting all the predefined goals, the process will terminate, and the best version of the code generated so far will be presented to the user. Convergence criteria can also be used as a termination condition when the improvements in the benchmarking results become negligible over successive iterations. For instance, if the performance metrics improve by less than 1% over three consecutive iterations, the system may determine that further iterations are unlikely to yield significant improvements and terminate the process.

In exemplary embodiments, time constraints can serve as a termination condition as well. Users can specify a maximum amount of time for the iterative process. For example, a user might set a time limit of 24 hours. If the process exceeds this time limit, it will terminate, and the best version of the code generated within the allotted time will be provided to the user. Resource constraints, such as limits on computational power or memory usage, can also act as termination conditions. If the system detects that it is approaching the specified resource limits, it can terminate the process to prevent overuse of resources and potential system instability.

In exemplary embodiments, users may choose to manually terminate the process based on their assessment of the generated code's quality and performance. The user interface can provide an option for users to stop the iterative process at any point and review the current version of the code. Error thresholds can be set to terminate the process if the generated code consistently fails to meet critical criteria. For example, if the code repeatedly fails security audits or critical functionality tests, the system may terminate the process to prevent further iterations that are unlikely to succeed. Additionally, a maximum cost constraint based on the cost of using the LLM can be set as a termination condition. Users can specify a budget for the iterative process, and if the cost of using the LLM exceeds this budget, the system will terminate the process. By defining multiple types of termination conditions, the system ensures that the iterative process is efficient and effective, providing users with optimized source code that meets their specific needs and requirements within reasonable limits.

In exemplary embodiments, when a termination condition is met and the performance thresholds have not been fully met, a selected version of the code to present to the user is determined based on a combination of factors that prioritize the most critical metrics and the overall improvement achieved during the iterative process. All versions of the code generated during the iterative process are evaluated based on predefined metrics, including performance, resource utilization, functionality, security, and sustainability. Each version's benchmarking results are compared to the user-defined thresholds to assess how closely they meet the desired goals.

In one embodiment, the metrics can be prioritized based on their importance to the user. For example, if performance and security are the most critical metrics, versions of the code that perform best in these areas will be given higher priority. The system may use a weighted scoring system to assign importance to each metric, ensuring that the most critical aspects are emphasized in the selection process. Each version of the code is assigned an aggregate score based on its performance across all metrics. The scoring system takes into account the weights assigned to each metric, providing a comprehensive evaluation of each version's overall quality. The version with the highest aggregate score is considered the selected version, i.e., the best version of the source code.

If the iterative process shows diminishing returns in terms of improvements, the system may consider the version that achieved the highest improvement rate before the convergence point. This ensures that the selected version represents the most significant progress made during the optimization process. User-defined constraints and preferences, such as preferred programming languages, coding standards, and specific libraries or frameworks, are also considered in the selection process. The best version should align with these preferences to ensure compatibility with the user's existing codebase and development practices.

Versions of the code that consistently fail to meet critical error thresholds, such as security audits or functionality tests, are excluded from consideration. This ensures that the selected version is free from major flaws that could impact its usability. Once the best version is determined, it is presented to the user along with a detailed report of its benchmarking results. The report includes information on how the version performed across all metrics, highlighting areas where it met or exceeded the thresholds and areas where it fell short. This transparency allows the user to make informed decisions about further refinement or acceptance of the code.

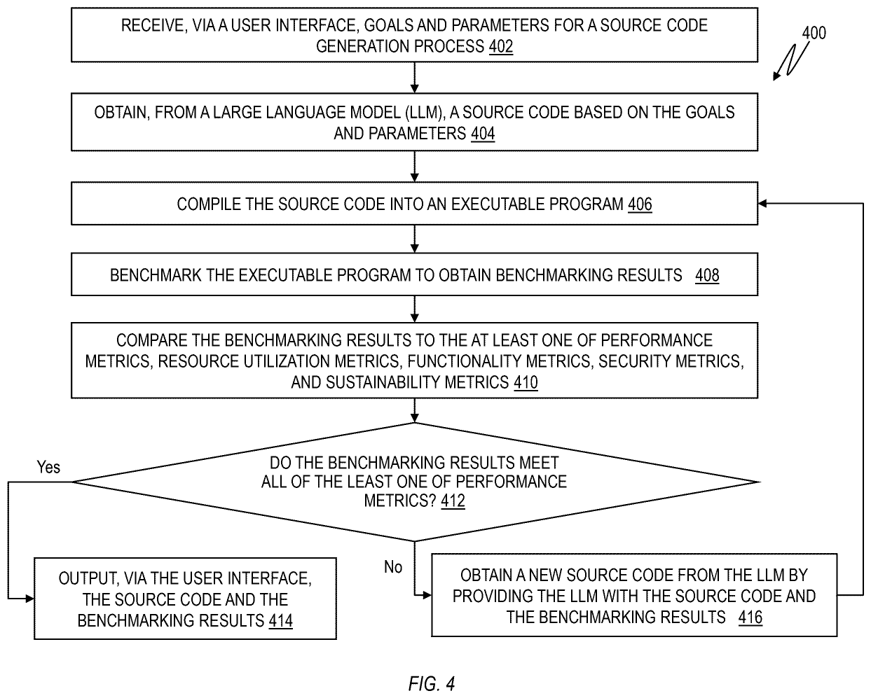

Referring now to FIG. 4, a flow chart illustrating a method 400 for automated source code generation and optimization using large language models and reinforcement learning is shown. In exemplary embodiments, the process flow 300 can be implemented by the system 200 as described in FIG. 3, which includes the software development environment 150 shown in FIG. 1.

At block 402, the method 400 includes receiving, via a user interface, goals and parameters for a source code generation process. These goals and parameters include at least one of the performance metrics, resource utilization metrics, functionality metrics, security metrics, and sustainability metrics. For example, a user might specify that the generated code should execute a particular function within a certain time frame, handle a specific number of transactions per second, or operate within a 50% CPU usage threshold. Next, as shown at block 404, the method 400 includes obtaining, from a large language model (LLM), a source code based on the goals and parameters. The LLM generates the initial source code by interpreting the provided goals and parameters. For instance, the LLM might generate code that performs a specific function while adhering to security best practices and minimizing CPU usage.

Next, as shown at block 406, the method 400 includes compiling the source code into an executable program. The compilation process ensures that the source code is syntactically correct and can be executed to perform the desired functions. For example, the compiler module transforms the generated source code into an executable program, enabling the executable program to be run and tested for various metrics. At block 408, the method 400 includes benchmarking the executable program to obtain benchmarking results. The benchmarking process evaluates the performance, resource utilization, functionality, security, and sustainability of the executable program. For instance, the benchmarking module might run the compiled executable program to evaluate its latency, throughput, CPU/memory utilization, unit test correctness, security vulnerabilities, and energy efficiency.

Next, as shown at block 410, the method 400 includes comparing the benchmarking results to the at least one of the performance metrics, resource utilization metrics, functionality metrics, security metrics, and sustainability metrics. This comparison determines whether the generated code meets the predefined goals. For example, the benchmarking results are compared to the predefined goals and parameters to determine if the generated code meets the desired criteria. At decision block 412, the method 400 includes determining whether the benchmarking results meet all of the least one of performance metrics. If the benchmarking results meet the predefined goals, the method 400 proceeds to block 414. If the benchmarking results do not meet the predefined goals, the method 400 proceeds to block 416.

At block 414, the method 400 includes outputting, via the user interface, the source code, and the benchmarking results. This step provides the user with the final version of the source code that meets the predefined goals. For example, the user interface displays the results of the automated software code generation, allowing the user to review the generated code and the performance metrics. At block 416, the method 400 includes obtaining a new source code from the LLM by providing the LLM with the source code and the benchmarking results. The LLM uses this feedback to generate an improved version of the source code, which is then recompiled and retested by the benchmarking module. This iterative loop continues until the source code meets all the predefined goals or another termination condition is reached. For example, the LLM might generate a revised source code that addresses the shortcomings identified in the benchmarking results, and this new version is then recompiled and retested.

In exemplary embodiments, termination conditions can include reaching a maximum number of iterations, meeting convergence criteria, time constraints, resource constraints, manual termination by the user, error thresholds, and maximum cost constraints. For example, a user might set a maximum of 50 iterations, a time limit of 24 hours, or a budget for the iterative process. If any of these conditions are met, the process will terminate, and the best version of the code generated so far will be presented to the user. When a termination condition is met and the performance thresholds have not been fully met, the best version of the code to present to the user is determined based on a combination of factors that prioritize the most critical metrics and the overall improvement achieved during the iterative process. For example, the system may use a weighted scoring system to assign importance to each metric, ensuring that the most critical aspects are emphasized in the selection process.

The method 400 can also include obtaining one or more test cases from the LLM. These test cases are designed to rigorously evaluate the functionality and performance of the executable code. For example, the LLM might create unit tests to verify that specific functions within the code produce the expected outputs, or it might generate stress tests to assess how the code performs under high-load conditions. In exemplary embodiments, benchmarking the executable program to obtain benchmarking results can include executing one or more test cases using the executable program. For example, the benchmarking module might run the generated test cases to evaluate the correctness and performance of the executable code.

The method 400 can also include providing one or more prompts to the LLM based on the goals and parameters and based on a set of templates stored in a software development environment. For example, the software development environment might generate prompts that outline the desired functionality and behavior of the generated code, ensuring that the LLM produces code that aligns with the predefined goals.

While the foregoing is directed to embodiments of the present disclosure, other and further embodiments of the present disclosure may be devised without departing from the basic scope thereof, and the scope thereof is determined by the claims that follow.

What is claimed is:

1. A computer-implemented method for automated source code generation and optimization, the method comprising:
receiving, via a user interface, goals and parameters for a source code generation process, wherein the goals and parameters include at least one of performance metrics, resource utilization metrics, functionality metrics, security metrics, or sustainability metrics;
obtaining, from a large language model (LLM), an initial source code based on the goals and parameters;
compiling the initial source code into an executable program;
benchmarking the executable program to obtain benchmarking results, wherein the benchmarking results include at least one of performance results, resource utilization results, functionality results, security results, or sustainability results;
comparing the benchmarking results to the at least one of performance metrics, resource utilization metrics, functionality metrics, security metrics, or sustainability metrics; and
based on a determination that the benchmarking results meet all of the least one of performance metrics, outputting, via the user interface, the source code and the benchmarking results.

2. The computer-implemented method of claim 1, further comprising:
based on a determination that the benchmarking results does not meet all of the least one of performance metrics, resource utilization metrics, functionality metrics, security metrics, and sustainability metrics, providing the source code and benchmarking results to the LLM to obtain a revised source code; and
iteratively compiling, benchmarking and comparing the revised source code until the benchmarking results meet all of the least one of performance metrics, resource utilization metrics, functionality metrics, security metrics, and sustainability metrics.

3. The computer-implemented method of claim 2, further comprising terminating the iterative compiling, benchmarking and comparing steps based on a determination that a termination condition has been reached.

4. The computer-implemented method of claim 3, wherein the termination condition includes at least one of reaching a maximum number of iterations, meeting convergence criteria, time constraints, resource constraints, manual termination by the user, error thresholds, or maximum cost constraints.

5. The computer-implemented method of claim 3, further comprising outputting a selected version of the source code to the user, wherein the selected version is identified based on the comparison of the benchmarking results to the at least one of performance metrics, resource utilization metrics, functionality metrics, security metrics, or sustainability metrics.

6. The computer-implemented method of claim 1, further comprising obtaining one or more test cases from the LLM.

7. The computer-implemented method of claim 6, wherein benchmarking the executable program to obtain benchmarking results includes executing the one or more test cases using the executable program.

8. The computer-implemented method of claim 1, further comprising providing one or more prompts to the LLM based on the goal and parameters and based on a set of templates stored in a software development environment.

9. A system comprising:
a memory comprising computer readable instructions; and
a processing device for executing the computer readable instructions, the computer readable instructions controlling the processing device to perform operations comprising:
receiving, via a user interface, goals and parameters for a source code generation process, wherein the goals and parameters include at least one of performance metrics, resource utilization metrics, functionality metrics, security metrics, or sustainability metrics;
obtaining, from a large language model (LLM), an initial source code based on the goals and parameters;
compiling the initial source code into an executable program;
benchmarking the executable program to obtain benchmarking results, wherein the benchmarking results include at least one of performance results, resource utilization results, functionality results, security results, or sustainability results;
comparing the benchmarking results to the at least one of performance metrics, resource utilization metrics, functionality metrics, security metrics, or sustainability metrics; and
based on a determination that the benchmarking results meet all of the least one of performance metrics, outputting, via the user interface, the source code and the benchmarking results.

10. The system of claim 9, wherein the operations further comprise:
based on a determination that the benchmarking results does not meet all of the least one of performance metrics, resource utilization metrics, functionality metrics, security metrics, and sustainability metrics, providing the source code and benchmarking results to the LLM to obtain a revised source code; and
iteratively compiling, benchmarking and comparing the revised source code until the benchmarking results meet all of the least one of performance metrics, resource utilization metrics, functionality metrics, security metrics, and sustainability metrics.

11. The system of claim 10, wherein the operations further comprise terminating the iterative compiling, benchmarking and comparing steps based on a determination that a termination condition has been reached.

12. The system of claim 11, wherein the termination condition includes at least one of reaching a maximum number of iterations, meeting convergence criteria, time constraints, resource constraints, manual termination by the user, error thresholds, or maximum cost constraints.

13. The system of claim 11, wherein the operations further comprise outputting a selected version of the source code to the user, wherein the selected version is identified based on the comparison of the benchmarking results to the at least one of performance metrics, resource utilization metrics, functionality metrics, security metrics, or sustainability metrics.

14. The system of claim 9, wherein the operations further comprise obtaining one or more test cases from the LLM.

15. The system of claim 14, wherein benchmarking the executable program to obtain benchmarking results includes executing the one or more test cases using the executable program.

16. The system of claim 9, wherein the operations further comprise providing one or more prompts to the LLM based on the goal and parameters and based on a set of templates stored in a software development environment.

17. A computer program product for circuit design optimization, the computer program product comprising:
a set of one or more computer-readable storage media;
program instructions, collectively stored in the set of one or more storage media, for causing a processor set to perform the following computer operations:
receiving, via a user interface, goals and parameters for a source code generation process, wherein the goals and parameters include at least one of performance metrics, resource utilization metrics, functionality metrics, security metrics, or sustainability metrics;
obtaining, from a large language model (LLM), an initial source code based on the goals and parameters;
compiling the initial source code into an executable program;
benchmarking the executable program to obtain benchmarking results, wherein the benchmarking results include at least one of performance results, resource utilization results, functionality results, security results, or sustainability results;
comparing the benchmarking results to the at least one of performance metrics, resource utilization metrics, functionality metrics, security metrics, or sustainability metrics; and
based on a determination that the benchmarking results meet all of the least one of performance metrics, outputting, via the user interface, the source code and the benchmarking results.

18. The computer program product of claim 17, wherein the operations further comprise:
based on a determination that the benchmarking results does not meet all of the least one of performance metrics, resource utilization metrics, functionality metrics, security metrics, and sustainability metrics, providing the source code and benchmarking results to the LLM to obtain a revised source code; and
iteratively compiling, benchmarking and comparing the revised source code until the benchmarking results meet all of the least one of performance metrics, resource utilization metrics, functionality metrics, security metrics, and sustainability metrics.

19. The computer program product of claim 18, wherein the operations further comprise terminating the iterative compiling, benchmarking and comparing steps based on a determination that a termination condition has been reached.

20. The computer program product of claim 19, wherein the termination condition includes at least one of reaching a maximum number of iterations, meeting convergence criteria, time constraints, resource constraints, manual termination by the user, error thresholds, or maximum cost constraints.
